(19) United States
(12) Patent Application Publication
(10) Pub. No.: US 2008/0263933 A1
(43) Pub. Date: Oct. 30, 2008

(54) FISHING LURE INCLUDING COFFEE AND METHOD OF PRODUCTION

(76) Inventor: Troy Gibson, Eufaula, AL (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/741,812

(22) Filed: Apr. 30, 2007

(51) Int. Cl. A01K 85/01; A01K 97/04

(52) U.S. Cl. 43/42.06; 426/1; 43/42

(57) ABSTRACT

A method of producing a fishing lure and a fishing lure produced therefrom wherein the method comprises forming a lure body from a plastic material having a coffee material incorporated therein and/or applying a coffee material to one or more exterior surfaces of the lure.

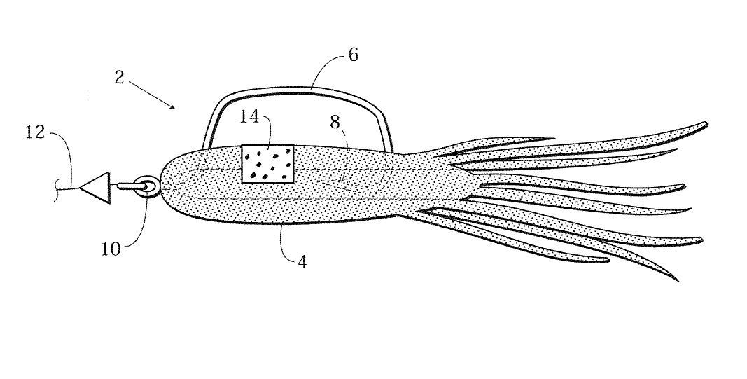

### FIELD OF THE INVENTION

The present invention relates to soft plastic fishing lures, also known as soft baits, and methods of production thereof.

### BACKGROUND OF THE INVENTION

Conventional fishing lures having soft plastic bodies formed in the shape of worms, frogs, lizards, minnows, or other creatures or objects are known in the art. In some instances the soft plastic body of the lure is formed with one or more hook structures contained therein. The lure may also include, or be adapted to connect with, other lure components such as leaders, weights, weed guards, spinners, blades, etc. Alternatively, the plastic body can simply be produced by itself, without any other components, in the form of a soft bait to which the fisherman adds his own hook and/or other items. As used herein and in the claims, the term “fishing lure” refers to all such lures and baits which include in while or in part, or which consist only of, a plastic body structure.

Methods of forming plastic fishing lures from plastisols and other compositions are well known in the art. Plastisols are commonly used for molding thermoplastic resins, e.g., polyvinylchloride, and other materials. The plastisol will typically comprise a dispersion of finely divided resin in a plasticizer. When heated to a sufficient temperature, such compositions typically form a gel as a result of the solvation of the resin particles by the plasticizer. Since plastisols are the prototypical compositions used to produce soft baits, a general explanation of the plastisol production process is provided below. But it should be recognized that that present invention is not limited to soft baits formed of plastisol. It is likewise applicable to, and encompasses, soft baits formed of non-plastisol gel like polymers and co-polymers or other compositions providing similar material characteristics.

One example of a molding process for producing a soft plastic fishing lure body structure from a vinyl chloride plastisol composition is disclosed in U.S. Pat. No. 4,530,179, the entire disclosure of which is incorporated herein by reference. The process utilizes a vinyl plastisol composition comprising a polyvinylchloride homopolymer or copolymer dispersion grade resin which is dispersed in one or more plasticizers or solvents. The plastisol composition also includes a stabilizer, a pigment material, and an amount of salt flour sufficient to impart a salty taste to the molded lure product.

Examples of suitable plasticizers disclosed in U.S. Pat. No. 4,530,179 include: diester plasticizers such as dioctyl phthalate or other phthalate diesters based on alcohols having from six to eleven carbon atoms; adipate diesters based on alcohols having from six to ten carbon atoms; and azelate diesters based on alcohols having from six to ten carbon atoms. The preferred plasticizer identified in the patent is dioctyl phthalate. The plasticizer is present in the plastisol composition in an amount of from about 50 to about 500 parts by weight to over 100 parts by weight of vinyl resin. If extenders or other secondary plasticizers are also used, the total plasticizer concentration in the plastisol composition can be as much as 800 parts by weight per 100 parts per weight of vinyl resin.

Examples of stabilizers suitable for use in the method disclosed in U.S. Pat. No. 4,530,179 include: combinations of metallic salts, such as various organic salts of barium, cadmium, and zinc; epoxies, such as epoxidized soybean oil and epoxidized tallate esters; and phosphites. The stabilizer material(s) will typically be present in an amount of from about 1 to about 10 parts by weight per 100 parts by weight of resin.

In the molding process disclosed in U.S. Pat. No. 4,530,179, the vinyl plastisol composition is placed in a suitable mold and is cured by heating to a gelation or fusion temperature typically in the range of from about 200° to about 400° F. The temperature employed can be varied to obtain the particular resilience, strength, and/or other physical properties desired.

In order to increase the effectiveness of soft plastic lures for attracting and catching fish, there is a continuing desire to improve lure compositions and production methods so that: (a) the fish will tend to hold the soft body portion of the lure in its mouth for a longer time, thus allowing more time for the fisherman to set the hook; (b) the lure will leave a scent trail which is particularly effective for drawing the fish to the lure; (c) any human scent which would otherwise be present on the lure as a result of handling will automatically be masked; and (d) the soft plastic body structure of the lure will have a more natural earthy color, appearance, and feel.

### SUMMARY OF THE INVENTION

The present invention provides a fishing lure and a method of production which satisfy the needs discussed above by incorporating a coffee material in, and/or depositing a coffee material on an exterior surface of, the plastic body structure of the lure.

In one aspect, there is provided an improved fishing lure comprising a lure body formed of a plastic material wherein the improvement comprises the plastic material having a coffee material incorporated therein. The coffee material will preferably be either a particulate coffee material, a coffee oil, liquid coffee, synthetic coffee scent, or a combination thereof. The coffee material will most preferably be a particulate coffee material.

In another aspect, there is provided a method of producing a fishing lure comprising the steps of: (a) forming a plastisol composition comprising a polyvinylchloride polymer dispersion resin and a coffee material and (b) forming a lure body from the plastisol composition. In one alternative, the step of forming the lure body can be performed by injection molding the plastisol composition. As another alternative, the step of forming the lure body can be performed by dipping a rod into the plastisol composition. As an example of yet another alternative, the step of forming the lure body can be performed by pouring the plastisol composition into a mold.

In another aspect, there is provided a fishing lure comprising a lure body having a coffee material on an exterior surface of the lure body. The coffee material will preferably be a particulate coffee material.

Further objects, features, and advantages of the present invention will be apparent to those of ordinary skill in the art upon examining the accompanying drawings and upon reading the following detailed description of the preferred embodiments.

### BRIEF DESCRIPTION OF THE DRAWING

The drawing is an elevational side view of an embodiment 2 of a fishing lure provided by the present invention.

### DETAILED DESCRIPTION OF THE PREFERRED EMBODIMENTS

As mentioned above, the plastic material used in the inventive method for forming the inventive fishing lure can be any plastic material known in the art for forming fishing lure bodies or similar objects. The composition used in the inventive method for forming the inventive fishing lure will preferably be a vinyl plastisol composition of the type described above or of any other type used in the art.

The inventive method will most preferably be performed using a vinyl chloride plastisol composition comprising: a high molecular weight polyvinylchloride homopolymer dispersion resin; a diester plasticizer in an amount in the range of from about 100 to about 500 parts by weight per 100 parts by weight of the polyvinylchloride resin; from about 50 to about 100 parts by weight of a paraffinic oil, a napthenic oil, or a combination thereof to improve the mold release characteristics of the product and to give a slightly oily feel to the plastic body structure of the finished lure; and from about 5 to about 15 parts by weight per 100 parts by weight of resin of one or more stabilizers (e.g., mixed metal salts of carboxylic acids and phosphite esters or epoxidized soybean oil) to prevent degradation at gelling temperatures. The preferred composition can also optionally include: one or more pigment materials; one or more filler materials (e.g., salt) for increasing the volume of the composition; or other components known in the art for providing desired physical or other characteristics.

In accordance with one aspect of the present invention, the plastic body of the fishing lure formed in accordance with the inventive method has a coffee material incorporated therein. The coffee material used in the inventive method for incorporation in the plastic body will preferably be a dry particulate coffee material (e.g., a ground, powdered, or otherwise particulated coffee bean material), a coffee oil, liquid coffee, synthetic coffee scent, or a combination thereof. The coffee material used for incorporation in the lure body will preferably be a dry particulate coffee material having a particle size in the range of from about 350 to about 10,000 microns and a bulk density in the range of from about 1.1 to about 1.2 grams per milliliter (more preferably from about 1.14 to about 1.19 grams per milliliter).

The amount of coffee incorporated in the plastic body of the fishing lure can be any amount which is effective for achieving the purposes of the present invention but which will not prevent the formation of the plastic body structure. If a dry particulate coffee material is used, the amount of coffee incorporated in the plastic body structure will preferably be an amount in the range of from about 0.5 to about 5 (most preferably about 2) cups of the coffee material per each gallon of the plastic material exclusive of the coffee material.

When using a vinyl plastisol or other plastisol composition for forming the body structure of the inventive reel, the inventive method will preferably comprise the step of adding from about 0.5 to about 5 cups (most preferably about 2 cups) of particulate coffee material to each gallon of the plastisol composition prior to, during, or after gelling or fusing the plastisol at the desired gelation temperature.

The process of forming the body structure of the inventive fishing lure using a plastisol and coffee composition can be accomplished using generally any procedure known in the art for forming fishing lures. Examples of such processes include, but are not limited to, injection molding, hand dipping, and hand pouring. In the case of injection molding and hand pouring, hook structures or other items can optionally be placed in the product mold for permanent incorporation in the finished plastic structure. When injection molding a vinyl plastisol composition in accordance with the inventive method, the plastisol composition will preferably be heated to a gelation temperature in the range of from about 200 to about 400° F., more preferably from about 350 to about 375° F., before, during, or after adding a coffee material thereto. The coffee containing composition will then be injected into an appropriate injection mold by pressure and allowed to cool. Similarly, if a hand pouring process is used, the coffee-containing plastisol material will be poured into an appropriately shaped mold or die.

Hand dipping processes are commonly used in the art for forming plastic worms and other “tube style” baits. If employed in the inventive method using a coffee-containing plastisol composition, the hand dipping technique will preferably comprise the steps of: heating the plastisol composition to a desired gelation temperature before, during, or after adding or including the coffee material; holding the gelled composition in a holding pan or other suitable container for performing the dipping operation; dipping one or more rods of a suitable length and diameter for forming the particular plastic worm bait or other tube-style bait into the gelled material; and then withdrawing the rod(s) from the gelled materials such that a suitable coating of the gelled material will remain and set on the rod structure. As will be understood by those in the art, hand dipping techniques of this type typically employ spindle devices, each having a plurality of rods extending therefrom which are simultaneously dipped in the plastic material.

An example of the inventive fishing lure 2 produced using the inventive process is shown in the drawing. The inventive fishing lure 2 comprises a soft plastic body structure 4 having a coffee material incorporated therein. The inventive lure 2 may also comprise a hook structure 6 which is formed in the lure structure 2. Otherwise, the hook structure 6 may be inserted into the lure structure 2 by the user. The hook structure 6 comprises a barbed hook 8 and an eyelet 10 for attaching the fishing line 12 thereto. The inventive fishing lure is not limited to any particular form of soft plastic body. For example, other conventional shapes for soft plastic bodies are illustrated in U.S. Pat. No. 4,993,183, also incorporated herein by reference.

The inventive fishing lure 2 also comprises a film or coating of coffee material 14 which is deposited and/or retained on the exterior surface of the lure body structure 4. The layer of coffee material 14 can be applied to the exterior of the lure body 4, for example: by dipping the lure in liquid coffee or coffee oil; applying particulate coffee material to the exterior of a hand-dipped lure at a point before the end of the setting process so that the particulate material is retained on the exterior surface of the lure; coating all or a portion of the interior surface of an injection or hand-pouring mold, or by any other suitable means.

It will also be understood that the inventive fishing lure can be formed such that (a) coffee material is only incorporated within the plastic body of the lure, (b) coffee material is only present on the exterior of the plastic body and/or other exterior surface of the lure, or (c) coffee material is both incorporated in the plastic lure body and present on one or more exterior surfaces of the lure.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. In a fishing lure comprising a lure body formed of a plastic material, the improvement comprising said plastic material having a coffee material incorporated therein.

2. The fishing lure of claim 1 wherein the improvement further comprises said coffee material being selected from the group consisting of a particulate coffee material, a coffee oil, liquid coffee, synthetic coffee scent, or a combination thereof.

3. The fishing lure of claim 1 wherein the improvement further comprises said coffee material being a particulate coffee material.

4. The fishing lure of claim 3 wherein the improvement further comprises said particulate coffee material being incorporated in said plastic material in an amount in the range of from about 0.5 to about 5 cups of said particulate coffee material per gallon of said plastic material exclusive of said coffee material.

5. The fishing lure of claim 4 wherein the improvement further comprises said particulate coffee material having an average particulate size in the range of from about 350 to about 10,000 microns.

6. The fishing lure of claim 1 wherein said plastic material has been produced from a vinyl chloride plastisol composition.

7. The fishing lure of claim 2 wherein said vinyl chloride plastisol composition was a composition comprising a polyvinylchloride homopolymer dispersion resin.

8. The fishing lure of claim 7 wherein said vinyl chloride plastisol was a composition further comprising:
at least one plasticizer;
a paraffinic oil, napthenic oil, or a combination thereof; and
at least one stabilizer.

9. The fishing lure of claim 1 wherein the improvement further comprises a coffee material on an exterior surface of said lure body.

10. A method of producing a fishing lure comprising the steps of:
(a) forming a plastisol composition comprising a polyvinylchloride polymer dispersion resin and a coffee material and
(b) forming a lure body from said plastisol composition.

11. The method of claim 10 wherein said lure body is formed from said plastisol composition in step (b) by injection molding said plastisol composition.

12. The method of claim 10 wherein said lure body is formed from said plastisol composition in step (b) by dipping a rod into said plastisol composition.

13. The method of claim 10 wherein said lure body is formed from said plastisol composition in step (b) by pouring said plastisol composition into a mold.

14. The method of claim 10 wherein said coffee material is selected from the group consisting of a particulate coffee material, a coffee oil, liquid coffee, or a combination thereof.

15. The method of claim 10 wherein said coffee material is a particulate coffee material.

16. The method of claim 15 wherein said coffee material is present in said plastisol composition in an amount in the range of from about 0.5 to about 5 cups of said coffee material per gallon of said plastisol composition exclusive of said coffee material.

17. The method of claim 15 wherein said particulate coffee material has an average particulate size in the range of from about 350 to about 10,000 microns.

18. The method of claim 10 further comprising the step of (c) applying a coffee material to an exterior surface of said lure body.

19. A fishing lure produced by the method of claim 10.

20. A fishing lure produced by the method of claim 11.

21. A fishing lure produced by the method of claim 12.

22. A fishing lure produced by the method of claim 13.

23. A fishing lure produced by the method of claim 18.

24. A fishing lure comprising a lure body having a coffee material on an exterior surface of said lure body.

25. The fishing lure of claim 24 wherein said coffee material is a particulate coffee material.
